(19) United States
(12) Patent Application Publication
(10) Pub. No.: US 2022/0186850 A1
(43) Pub. Date: Jun. 16, 2022

(54) CHECK-VALVE

(71) Applicant: Danfoss A/S, Nordborg (DK)

(72) Inventor: Frank Holm Iversen, Padborg (DK)

(21) Appl. No.: 17/547,549

(22) Filed: Dec. 10, 2021

(30) Foreign Application Priority Data
Dec. 16, 2020 (EP) 20214683.3

(51) Int. Cl. F16K 15/06

(52) U.S. Cl. CPC F16K 15/063

(57) ABSTRACT

A check-valve (1) including a housing (2, 3) having an inlet (5), an outlet (6), a fluid flow path between the inlet (5) and the outlet (6) and a valve seat (7) in the fluid path, the valve seat (7) having a valve seat axis (8), a valve element (9), a valve element support (12) arranged in the housing (2, 3) and supporting the valve element (9), is described, wherein the section (19) of the fluid flow path is formed between the housing (2, 3) and the valve element support (12) and the valve element (9) is moveable between a position in which it rests against the valve seat (7) and a position in which contacts against the valve element support (12). Such a check-valve should have a simple construction keeping low noise and wear. To this end, the valve element support (12) includes at least one recess (12) having an open side to the section (19) of the fluid flow path and connecting the section (19) of the fluid flow path to a space between the valve element (9) and the valve element support (12.)

### CROSS-REFERENCE TO RELATED APPLICATION

This application claims foreign priority benefits under 35 U.S.C. § 119 to European Patent Application No. 20214683.3 filed on Dec. 16, 2020, the content of which is hereby incorporated by reference in its entirety.

### TECHNICAL FIELD

The present invention relates to a check-valve comprising a housing having an inlet, an outlet, a fluid flow path between the inlet and the outlet and a valve seat in the fluid flow path, the seat having a valve seat axis, a valve element, a valve element support arranged in the housing and supporting the valve element, wherein a section of the flow path is formed between the housing and the valve element support and the valve element is moveable between a position in which it rests against the valve seat and a position in which contacts the valve element support.

### BACKGROUND

Such a check-valve is known, for example, from EP 1 640 584 B1.

The invention relates in particular to a check-valve having a large flow capacity up to 100 m³/h. Such a check-valve has a large diameter of up to three inch and is in particular suitable for the desalination of salt water by means of reverse osmosis or treatment of waste water.

A check-valve should open as much as possible when the flow is directed in the passing direction, the opening movement should be as fast as possible. The check-valve should close as fast as possible when the direction of flow is reversed. Furthermore, the check-valve must work reliably even when it is mounted in an orientation where the valve element has to be moved against the direction of gravity. Thus, a force producing means driving the valve element in closing direction must produce at least a force to overcome stucking of the valve element. If the flow direction through the valve is upwards in direction of gravity, the force producing means must be able to overcome the impact of gravity on the valve element.

The effect of the combination of opening forces produced by the fluid flow and the closing forces in the opposite direction lead to the effect that the valve element although it can be moved to contact the valve element support does not rest against the valve element support. This increases flow losses, since the valve is not fully open, and produces wear.

### SUMMARY

The object underlying the invention is to have a simple construction of a check-valve keeping low pressure loss and wear.

This object is solved with a check-valve as described at the outset in that the valve element support comprises at least one recess having an open side to the section of the fluid flow path and connecting the section of the fluid flow path to a space between the valve element and the valve element support.

The recess is formed in a side wall of the valve element support. Fluid flowing through the section of the flow path produces a vortex formation in the recess which in turn lowers the pressure in the recess. This lower pressure propagates into the space between the valve element and the valve element support leading to the effect that the valve element is not only pushed by the incoming fluid in a direction towards the valve element support, but that the valve element is in addition dragged in a direction to the valve element support. This improves the opening behaviour of the check-valve since the valve element can be moved rather fast to the valve element support.

In an embodiment of the invention the valve element and the valve element support form a chamber when the valve element rests against the valve element support, wherein the chamber is connected to the section of the fluid flow path via the recess. The lower pressure produced by the vortex formation in the recess propagates into the chamber between the valve element and the valve element support and drags the valve element against the valve element support. This reduces the risk of the valve element lifting off the valve element support. The valve element can be held reliably against the valve element support so that a movement between the valve element and the valve element support can be inhibited once the valve element is in the fully open position and rests against the valve element support. The valve element is sucked against the valve element support.

In an embodiment of the invention the valve element is concave on the side facing the valve element support. The concave form is a simple way to form the chamber in which the lower pressure can be distributed evenly over the whole area of the valve element.

In an embodiment of the invention the valve element is flat or concave at a side facing away from the valve element support. In this way the valve element produces a larger flow resistance for the fluid flow through the check-valve. This larger flow resistance is used to open the check-valve fast and to assist in holding the check-valve in the open position.

In an embodiment of the invention the valve element comprises a stem which is guided in the valve element support. In this way it is possible to move the valve element along the valve seat axis only.

In an embodiment of the invention a bushing of a material different from the material of the valve element support forms a guide of the stem. The bushing is arranged in the valve element support. The stem does not have direct contact to the valve element support, but only contact to the bushing. This has the advantage that the material of the valve element support can freely be chosen, for example on basis of economic reasons. Furthermore, the material of the bushing can be chosen so that a friction between the stem and the bushing can be kept small.

In an embodiment of the invention a spring is arranged around the stem and the valve element support comprises a bore accommodating the stem, a groove surrounding the bore, and a wall between the bore and the groove, wherein part of the spring is arranged in the groove. In this way it is possible to use a spring having a low spring force ratio. A low spring force is wanted in the compressed position (open valve) and a high spring force is wanted in expanded position (valve closed, spring pressing valve element against valve seat).

In an embodiment of the invention the valve element support is made of plastic material. A plastic material can simply be formed, for example by injection moulding or by 3D-printing. Furthermore, it is in most cases cheaper than a metal.

In an embodiment of the invention the recess has a curved shape. The recess can be limited, for example, by a section of a cylinder wall or a cone wall, wherein the axis of this cylinder wall or cone wall is located out of the valve element support. Such a rounded recess is simple to manufacture and produces the vortex with the necessary effect.

In an embodiment of the invention the valve element support comprises a plurality of arms connecting the valve element support to the housing. The arms are integral with the valve element support. Usually a number of three arms is sufficient. The recess can be arranged between two arms. In a region between two arms the velocity of the flow of fluid is the largest. It is also possible to arrange a recess between each pair of arms. In other words, when there are three arms, there are also three recesses. The arms and the recesses are distributed evenly in circumferential direction.

In an embodiment of the invention the arms are connected by a ring. This contributes to the stability of positioning the valve element support in the housing.

In an embodiment of the invention the ring is clamped between a step in the first housing part and the second housing part. The step in the first housing allows a precise positioning of the valve element support in relation to the valve seat.

In an embodiment of the invention the ring bears a sealing ring. The sealing ring prevents fluid from leaking to the outside, for example through a gap or contact face between the first housing part and the second housing part.

In an embodiment of the invention the second housing part comprises a circumferential protrusion inserted into a radial gap between the ring and the first housing part and compressing the sealing ring. The sealing ring is compressed in axial direction and takes up tolerances on the height of the ring. Due to this compression the ring may expand or tries to expand in a direction perpendicular to the axial direction. This means that the sealing ring is pressed against the first housing part on the radial outer side and to the ring connecting the arms on the radial inner side and thus sealing the housing to the outside.

### BRIEF DESCRIPTION OF THE DRAWINGS

An embodiment of the invention will now be described with reference to the drawing, in which:

FIG. 1 shows a schematic sectional view of a check-valve and

FIG. 2 shows a valve element support in perspective view.

### DETAILED DESCRIPTION

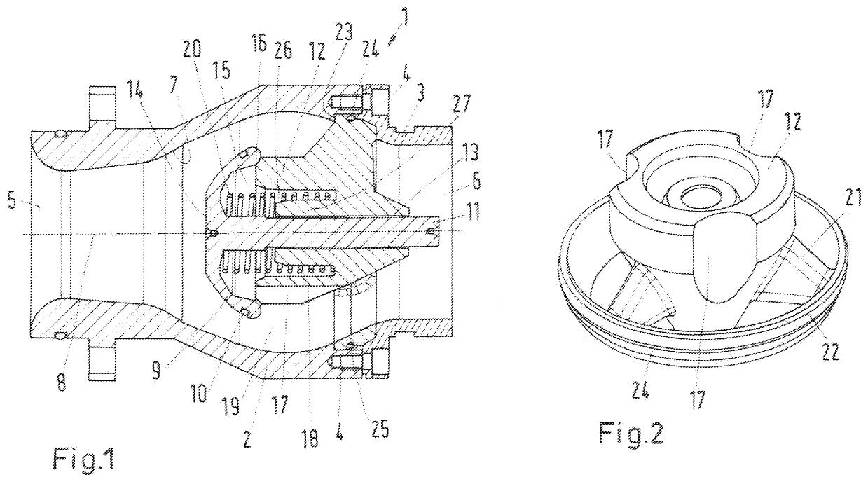

FIG. 1 shows schematically in a sectional view a check-valve 1. The check-valve 1 comprises a housing having a first housing part 2 and a second housing part 3. The first housing part 2 and the second housing part 3 are connected by means of screws 4 or the like, for example, a Victaulic clamp. It is also possible to replace the second housing part 3 with a tube or an end of a tube.

The first housing part comprises an inlet 5. The second housing part 3 comprises an outlet 6. The terms “inlet” and “outlet” relate to the flow of fluid through the check-valve 1.

The first housing part 5 comprises a valve seat 7 which is arranged between the inlet 5 and the outlet 6. The valve seat 7 defines a valve seat axis 8. In the present embodiment the valve seat axis 8 coincides with the middle axis of the inlet 5 and the outlet 6.

The check-valve 1 comprises a valve element 9. The valve element 9 comprises a valve element ring 10, for example in form of an O-ring.

The valve element 9 comprises a stem 11 with which the valve element 9 is guided in a valve element support 12.

The valve element support 12 can be made of a plastic material. It comprises a bore in which a bushing 13 is arranged. The bushing 13 is made of a material different from the material of the valve element support 12. The bushing can be made, for example, from Polyetheretherketone (PEEK). The material of the valve element support 12 can be a cheaper material, for example POM.

The stem 11 can be made of the same material as the valve element 9. This material can be, for example, stainless steel. The same material can be used for the two housing parts 2, 3.

The valve element 9 comprises a front face 14 which is flat (as shown) or concave. This front face 14 faces away from the valve element support 12.

On the side facing the valve element support 12 the valve element 9 is concave forming a chamber 15 together with the valve element support when the valve element 9 contacts the valve element support with its outer rim 16.

The valve element support comprises three recesses 17 which are distributed around the circumference of the valve element support 12. The recesses 17 are cut-outs in a circumferential wall of the valve element support 12. They are rounded. The round form can correspond, for example, to a part of an outer surface of a cylinder or a cone. A bottom 18 of the recesses 17 runs preferably parallel to the valve seat axis 8.

A flow path between the inlet 5 and the outlet 6 comprises a section 19 between the valve element support 12 and the first housing part 2. The recesses 17 are located in this section 19.

The valve element 9 protrudes in radial direction (in relation to the valve seat axis 8) over the valve element support 12. The valve element 9 together with the valve element support 12 has the form of a droplet when the valve element 9 rests against the valve element support 12.

A flow of fluid passing the section 19 creates a vortex in the recesses 17. This vortex formation decreases the pressure in the recesses 17. This decreased pressure propagates to the chamber 15 and produces a dragging or sucking force sucking the valve element 9 against the valve element support 12.

Thus, when the check-valve 1 is in the fully open condition, as shown in FIG. 1, where the valve element 9 rests against the valve element support 12, the valve element 9 is reliably held against the valve element support 12. The suction force produced by the vortex in the recesses 17 and the force produced by the flow of fluid acting on the valve element 9 from the side of the inlet is larger than the force of a spring 20 acting on the valve element 9 in closing direction, i.e. away from the valve element support 12.

The reduced pressure in the recesses 17 does not only act on the valve element 9 when the valve element 9 is in the fully open condition. Once a flow has been established through the check-valve 1 and reaches the recesses 17, a reduced pressure is produced between the valve element 9 and the valve element support 12 helping to move the valve element 9 towards the valve element support 12.

The valve element support 12 comprises three arms 21 which are distributed in circumferential direction. The arms 21 are made in one piece with the valve element support 12. The arms 21 are connected by a ring 22.

The first housing part 2 comprises a step 23. In a mounted condition the ring 22 rests against the step 23 and is held against the step 23 by means of the second housing part 3 or, when a tube is used instead of the second housing element, by the tube. In this way it is possible to position the valve element support 12 with high precision in relation to the valve seat 7.

A sealing ring 24 is arranged on the radial outer side of ring 22. The second housing part 3 comprises a circumferential protrusion 25 which is inserted into a radial gap between the ring 22 and the first housing part 2. When the second housing part 3 is connected to the first housing part 2 this circumferential protrusion 25 comes in contact with the sealing ring 24 and compresses it slightly in axial direction. The sealing ring 24 which is in form of an O-ring is thus compressed in axial direction and expands in radial direction, i.e. it is pressed in radial outward direction to the inner side of the first housing part 2 and in radial inner direction to the radial outer face of ring 22. Thus, the valve element support 12 is positioned in the first housing part 2 via the sealing ring 24.

The valve seat support 12 comprises a groove 26 accommodating a part of the spring 20. A wall 27 is arranged between the groove 26 and the bore of the valve seat support 12 accommodating the stem 11. Thus, it is possible to have a spring 20 with a relatively large diameter. The consequence is that the spring 20 can be made relatively long and therby have a lower spring force ratio. This has the effect that the valve element support 12 can be positioned close to the valve seat 7 so that in a closed position of the check-valve 1 the free or unsupported length of the stem 11 can be kept short.

The valve element support 12 can be injection moulded, milled or 3D-printed.

In principle a single recess 17 would be sufficient. However, in order to have dragging forces which are equally distributed between the valve element 9 and the valve element support 12 more than one recess 17 is preferred.

The recesses 17 are arranged in the section 19 of the flow path in which the fluid has high velocity.

Such a check-valve is in particular suitable to control a large volume flow of up to 100 m³/h. The outlet 6 can have an inner diameter of 60 to 100 mm. The check-valve 1 can preferably be used for the desalination of salt water or the treatment of waste water by reverse osmosis.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A check-valve comprising a housing having an inlet, an outlet, a fluid flow path between the inlet and the outlet and a valve seat in the fluid flow path, the valve seat having a valve seat axis, a valve element, a valve element support arranged in the housing and supporting the valve element, wherein a section of the fluid flow path is formed between the housing and the valve element support and the valve element is movable between a position in which it rests against the valve seat and a position in which it contacts the valve element support, wherein the valve element support comprises at least one recess having an open side to the section of the fluid flow path and connecting the section of the fluid flow path to a space between the valve element and the valve element support.

2. The check-valve according to claim 1, wherein the valve element and the valve element support form a chamber when the valve element rests against the valve element support, wherein the chamber is connected to the section of the fluid flow path via the recess.

3. The check-valve according to claim 2, wherein the valve element is concave on the side facing the valve element support.

4. The check-valve according to claim 1, wherein the valve element is flat or concave at a side facing away from the valve element support.

5. The check-valve according to claim 1, wherein the valve element comprises a stem which is guided in the valve element support, wherein a bushing of a material different from the material of the valve element support forms a guide of the stem.

6. The check-valve according to claim 1, wherein a spring is arranged around the stem and the valve element support comprises a bore accommodating the stem a groove surrounding the bore, and a wall between the bore and the groove, wherein part of the spring is arranged in the groove.

7. The check-valve according to claim 1, wherein the valve element support is made of a plastic material.

8. The check-valve according to claim 1, wherein the recess has a curved shape.

9. The check-valve according to claim 1, wherein the valve element support comprises a plurality of arms connecting the valve element support to the housing.

10. The check-valve according to claim 9, wherein the housing comprises a first housing part and a second housing part, wherein a radial outer end of the arms is arranged between the first housing part and the second housing part.

11. The check-valve according to claim 9, wherein the arms are connected by a ring.

12. The check-valve according to claim 11, wherein the ring is clamped between a step in the first housing part and the second housing part.

13. The check-valve according to claim 11, wherein the ring bears a sealing ring.

14. The check-valve according to claim 13, wherein the second housing part comprises a circumferential protrusion inserted into a radial gap between the ring and the first housing part and compressing the sealing ring.
